(19) United States
(12) Patent Application Publication
(10) Pub. No.: US 2026/0120249 A1
(43) Pub. Date: Apr. 30, 2026

(54) DEVICE AND METHOD FOR AI-BASED NLOS (NON-LINE-OF-SIGHT) IMAGING RECONSTRUCTION

(71) Applicant: UIF (UNIVERSITY INDUSTRY FOUNDATION), YONSEI UNIVERSITY, Seoul (KR)

(72) Inventors: Seon Joo Kim, Seoul (KR); In Cho, Seoul (KR)

(73) Assignee: UIF (UNIVERSITY INDUSTRY FOUNDATION), YONSEI UNIVERSITY, Seoul (KR)

(21) Appl. No.: 18/934,160

(22) Filed: Oct. 31, 2024

(30) Foreign Application Priority Data
Oct. 30, 2024 (KR) 10-2024-0150359

(51) Int. Cl. G06T 5/70; G06T 5/10; G06T 7/50; G06T 7/70

(52) U.S. Cl. CPC G06T 5/70; G06T 5/10; G06T 7/50; G06T 7/70; G06T 2207/20084

(57) ABSTRACT

The present invention relates to an artificial intelligence-based non-line-of-sight (NLOS) imaging reconstruction device and includes an input processing unit that samples a partial video from an original image, a neural network processing unit that generates a frequency-converted video for the partial video and inputs the frequency-converted video to time and frequency domain networks to generate a predicted phasor field, and a scene reconstruction unit that reconstructs a hidden scene based on the predicted phasor field.

### CROSS-REFERENCE TO RELATED APPLICATION

This application claims under 35 U.S.C. § 119(a) the benefit of Korean Patent Application No. 10-2024-0150359 filed on Oct. 30, 2024, the entire contents of which is incorporated herein by reference.

### TECHNICAL FIELD

The present invention relates to an artificial intelligence-based non-line-of-sight (NLOS) imaging reconstruction technology, and more specifically, to an artificial intelligence-based non-line-of-sight (NLOS) imaging reconstruction device and method capable of reconstructing a hidden scene based on a predicted phasor field generated by inputting a frequency-transformed video of a partial video generated through a neural network to time and frequency domain networks.

### BACKGROUND

An artificial intelligence-based image reconstruction technology refers to a technology for utilizing artificial intelligence (AI) and machine learning (ML) algorithms to restore a damaged or partially missing image or to convert a low-resolution image into a high-resolution image. This technology is used to fill missing parts in an image or to convert the image to reconstruct the image with better quality. To this end, deep learning algorithms, especially generative models and convolutional neural networks (CNNs) are mainly utilized.

Korean Patent Publication No. 10-2022-0180535 (Dec. 21, 2022) includes a step of setting a mask for a plurality of parts based on an original image, a step of outputting a latent code for generating a first image reconstructed for each of the plurality of parts from the original video based on a first artificial intelligence learning model, a step of generating the first images reconstructed from the latent code for each of the plurality of parts based on a second artificial intelligence learning model, and a step of applying the mask to each of the first images generated for each of the plurality of parts and combining the first images to which the mask is applied, to generate a second image reconstructed for the original video.

### PRIOR ART LITERATURE

### Patent Literature

Korean Patent Publication No. 10-2022-0180535 (Dec. 21, 2022)

### DESCRIPTION

### Problem to be Solved

An embodiment of the present invention provides an artificial intelligence-based non-line-of-sight (NLOS) imaging reconstruction device and method capable of generating a frequency-converted video for a partial video through a neural network and inputting the frequency-converted video to time and frequency domain networks to generate a predicted phasor field.

An embodiment of the present invention provides an artificial intelligence-based non-line-of-sight (NLOS) imaging reconstruction device and method capable of reconstructing a hidden scene based on a predicted phasor field.

An embodiment of the present invention provides an artificial intelligence-based non-line-of-sight (NLOS) imaging reconstruction device and method capable of performing denoising through sensor noise simulation in a partial video to generate a denoised partial video.

### Solution

In embodiments, an artificial intelligence-based non-line-of-sight (NLOS) imaging reconstruction device includes an input processing unit configured to sample a partial video from an original image; a neural network processing unit configured to generate a frequency-converted video for the partial video and input the frequency-converted video to time and frequency domain networks to generate a predicted phasor field; and a scene reconstruction unit configured to reconstruct a hidden scene based on the predicted phasor field.

The input processing unit may perform denoising through sensor noise simulation on the partial video to generate a denoised partial video.

The neural network processing unit may perform an input phasor convolution for generating the frequency-converted video by performing FFT transform, application of an illumination function, and IFFT transform on the partial video, and the illumination function may extract a frequency band of interest by passing a specific frequency band in a frequency band of the partial video.

The neural network processing unit may input the frequency-converted video to the time domain network implemented as a residual block for temporal information processing, to generate a temporal information preserving image.

The neural network processing unit may input the temporal information preserving image to the frequency domain network implemented as a convolutional layer for processing frequency components of the temporal information preserving image, to generate a frequency information-processed video.

The neural network processing unit may extract a frequency band of interest from the frequency information-processed video through target training to generate the predicted phasor field for predicting the hidden object.

The neural network processing unit may implement the target training using a loss function for controlling outliers of the hidden object.

The scene reconstruction unit may determine a position and shape of the object through a Rayleigh-Sommerfeld diffraction (RSD) operation for the frequency band constituting the predicted phasor field, to restore the hidden scene.

In embodiments, an artificial intelligence-based non-line-of-sight (NLOS) imaging reconstruction method performed in an artificial intelligence-based non-line-of-sight (NLOS) imaging reconstruction device includes an input processing step of sampling a partial video from an original image; a neural network processing step of generating a frequency-converted video for the partial video and inputting the frequency-converted video to time and frequency domain networks to generate a predicted phasor field; and a scene reconstruction step of reconstructing a hidden scene based on the predicted phasor field.

### Effect

The disclosed technology can have the following effects. However, since this does not mean that a specific embodiment should include all of the following effects or only the following effects, the scope of the disclosed technology should not be understood as being limited thereby.

According to the artificial intelligence-based non-line-of-sight (NLOS) imaging reconstruction device and method according to an embodiment of the present invention, it is possible to generate a frequency-converted video for a partial video through a neural network and input the frequency-converted video to time and frequency domain networks to generate a predicted phasor field.

According to the artificial intelligence-based non-line-of-sight (NLOS) imaging reconstruction device and method according to an embodiment of the present invention, it is possible to reconstruct a hidden scene based on a predicted phasor field.

According to the artificial intelligence-based non-line-of-sight (NLOS) imaging reconstruction device and method according to an embodiment of the present invention, it is possible to generate a denoised partial video by performing denoising through sensor noise simulation on a partial video.

### BRIEF DESCRIPTION OF THE DRAWINGS

FIG. 1 is a diagram illustrating an artificial intelligence-based non-line-of-sight (NLOS) imaging reconstruction device according to an embodiment of the present invention.

FIG. 2 is a diagram illustrating a functional configuration of the artificial intelligence-based non-line-of-sight (NLOS) imaging reconstruction device of FIG. 1.

FIG. 3 is a diagram illustrating a system configuration of an artificial intelligence-based non-line-of-sight (NLOS) imaging reconstruction device of FIG. 1.

FIG. 4 is a flowchart illustrating an artificial intelligence-based non-line-of-sight (NLOS) imaging reconstruction method according to the present invention.

FIG. 5 is a diagram illustrating an illumination function (left) in a frequency domain and reconstruction results (right) of FK for a frequency-filtered measurement.

FIG. 6 is a diagram illustrating qualitative results for a bike and a dragon in a Stanford real dataset.

FIG. 7 is a diagram illustrating the qualitative results related to the resolution for non-confocal 16×16 sparse sampling in the real dataset.

FIG. 8 is a diagram illustrating qualitative ablation results for a denoising criterion.

FIG. 9 is a diagram illustrating qualitative ablation results for frequency filtering.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

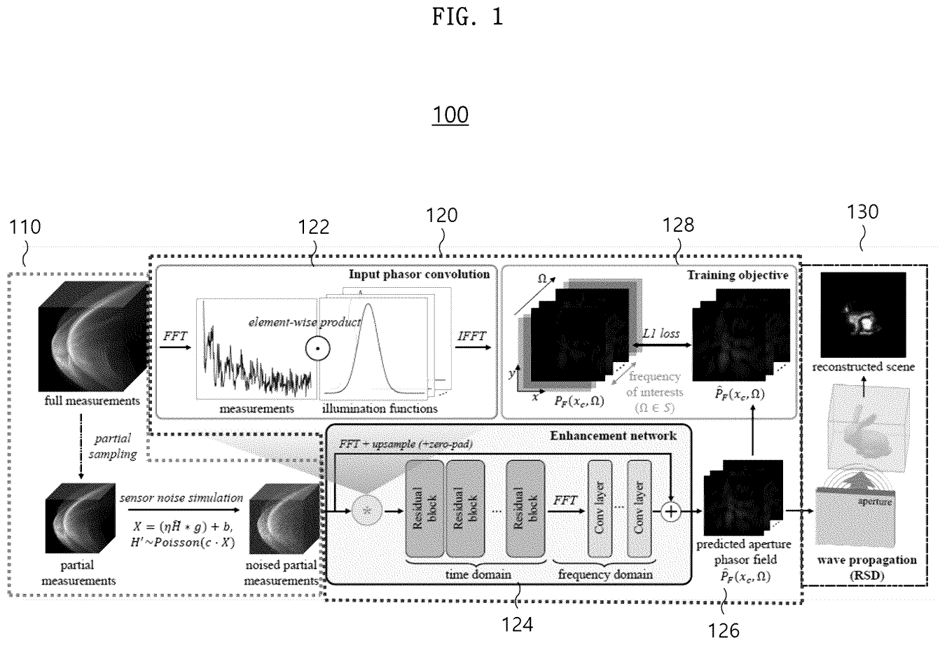

FIG. 1 is a diagram illustrating an artificial intelligence-based non-line-of-sight (NLOS) imaging reconstruction device according to an embodiment of the present invention.

Referring to FIG. 1, the artificial intelligence-based non-line-of-sight (NLOS) imaging reconstruction device 100 may include an input processing unit 110, a neural network processing unit 120, and a scene reconstruction unit 130, and the neural network processing unit 120 may include an input phasor convolution module 122, a time domain network module 124, a predicted phasor field generation module 126, and a target training module 128.

The input processing unit 110 may sample a partial video from an original image.

More specifically, an operation of the input processing unit 110 is as follows.

Since processing entire data of the original video consumes a lot of computational resources, the input processing unit 110 may selectively samples a partial region containing important information from the entire image to reduce an amount of data, thereby increasing a processing speed and enabling real-time processing.

The input processing unit 110 may exclude unnecessary regions or portions that may include noise of the original video from a processing target, thereby improving quality of signal and focusing on important information.

Sampling schemes includes random sampling which can obtain data representing an entire image by randomly selecting and sampling several parts of an original video, importance-based sampling which can perform subsequent processing based on higher quality data by preferentially sampling regions containing important information (for example, regions where there are objects) in the original video, and region-based sampling which is advantageous for intensively analyzing regions where the objects are positioned, in NLOS imaging, by selectively extracting and sampling specific parts (for example, a center or a boundary of a specific object) of the video.

The neural network processing unit 120 may generate a frequency-converted video for a partial video and input the frequency-converted video to the time and frequency domain networks to generate a predicted phasor field.

More specifically, an operation of the neural network processing unit 120 is as follows.

The neural network processing unit 120 may extract components in a specific frequency band from the video through a frequency transform, which is a process of converting an input partial video from a time domain to a frequency domain, and analyze a feature of an object based on the components, and, in such a process, it is possible to reduce noise and emphasize the important information.

The neural network processing unit 120 may input the video obtained through frequency transform to two networks including a time domain network and a frequency domain network, which can learn and combine important features in respective domains to derive prediction results. Here, the time domain network may analyze temporal change in the video, and for example, estimate a position of the object by learning a movement of the object or change in signal over time. The frequency domain network may filter frequency components of the video in the frequency domain, improve the quality of the signal by emphasizing a specific frequency band or removing noise components, and more accurately predict a shape of the object.

The neural network processing unit 120 may generate the predicted phasor field including phase and amplitude information of the wave reflected from the object as final results generated by the neural network processing unit. Here, the predicted phasor field contains important information indicating a position and shape of the object, and the hidden scene can be restored through a Rayleigh-Sommerfeld diffraction (RSD) operation or the like in a subsequent step.

The scene reconstruction unit 130 may reconstruct the hidden scene based on the predicted phasor field.

More specifically, an operation of the scene reconstruction unit 130 is as follows.

The scene reconstruction unit 130 may analyze a manner in which the wave reflected from the object propagates based on the predicted phasor field, and visually indicate what shape the hidden object actually has and where the object is positioned, by restoring the position and shape of the object.

The scene reconstruction unit 130 may compute a diffraction phenomenon appearing when the wave reflected from the object goes around an obstacle and propagates, by using Rayleigh-Sommerfeld diffraction (RSD), which is a major mathematical model used in scene reconstruction. Here, in the RSD operation, how the wave reflected from the object propagates and how the wave has an influence on the position or shape of the object are mathematically modelled, thereby accurately restoring information on the hidden object. An RSD formula is as follows.

$$u ( P ) = \frac{1}{i λ} {\int }_{S} ( \frac{{e}^{ikr}}{r} ) cos ( θ ) ds$$

u(P) denotes how a wave is diffracted and reflected at a specific point PPP, λ denotes a length of the wavelength, r denotes a traveling distance of the wave, and θ denotes an angle of incidence.

The scene reconstruction unit 130 may estimate an exact position of the hidden object by analyzing a path of the wave reflected from the object using the predicted phasor field.

The scene reconstruction unit 130 may provide information including a size, boundary, and surface shape of the object by analyzing the diffraction and reflection patterns of the waves and restoring the shape of the object, since the reflected waves of the object have an influence on an outer shape of the object.

The scene reconstruction unit 130 can also provide a very precise image even in a situation where the object is not directly visible, by not only simply estimating the position and shape of the object, but also reconstructing a high-resolution image of the object.

The scene reconstruction unit 130 can provide a comprehensive understanding of the hidden scene through the reconstructed image including information on not only the outer shape of the object but also the surrounding environment thereof.

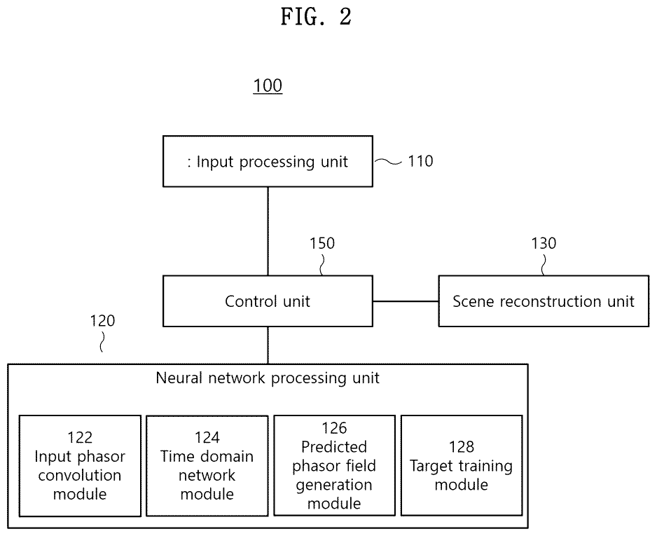

FIG. 2 is a diagram illustrating a functional configuration of the artificial intelligence-based non-line-of-sight (NLOS) imaging reconstruction device of FIG. 1.

Referring to FIG. 2, the artificial intelligence-based non-line-of-sight (NLOS) imaging reconstruction device 100 may include an input processing unit 110, a neural network processing unit 120, and a scene reconstruction unit 130, and the neural network processing unit 120 may include an input phasor convolution module 122, a time domain network module 124, a predicted phasor field generation module 126, and a target training module 128.

The input processing unit 110 may perform denoising through sensor noise simulation on the partial video to generate a denoised partial video.

More specifically, the input processing unit 110 may simulate sensor noise that may occur in an actual environment and learn patterns and characteristics of the noise that may occur by applying a denoising algorithm that takes this into account. These sensor noises may be irregular signals that are generated in a process of collecting video data, may generally appear as Gaussian noise, Poisson noise, or the like, and may be generated for various reasons such as sensor performance, environmental factors, and signal fluctuation.

The input processing unit 110 processes data containing the simulated noise to remove unnecessary noise components and leave only important signal components. To this end, the input processing unit 110 may use various filtering techniques or neural networks, a representative method is a scheme for learning and removing noise through a median filter that can remove noise using values of surrounding pixels and maintain the clarity of an original video, a Gaussian filter that can curb noise based on a Gaussian distribution and create a smoother image, and a deep learning model, and includes, for example, a neural network-based removal which is particularly effective for complex noise patterns.

The input processing unit 110 may provide more accurate data to a learning and inferring process of the neural network as a result of reducing an influence of the sensor noise and revealing important signal components more clearly through generation of the denoised partial video, which is a result generated after noise is removed from the original video and is clean data to be used for subsequent processing.

The neural network processing unit 120 may include an input phasor convolution module 122, a time domain network module 124, a predicted phasor field generation module 126, and a target training module 128.

The input phasor convolution module 122 performs FFT transform, application of an illumination function, and IFFT transform on the partial video to generate a frequency-converted video.

The input phasor convolution module 122 may perform input phasor convolution for generating a frequency converted video by performing FFT transform, application of illumination function, and IFFT transform on the partial image, and the illumination function may extract the frequency band of interest by passing a specific frequency band in the frequency band of the partial video.

More specifically, the input phasor convolution module 122 may separate a signal in the time domain into frequency components using Fast Fourier Transform (FFT) and extract important frequency components in the video through this.

Further, the input phasor convolution module 122 acts as a filter for frequency-converted data obtained through the FFT, and may apply the illumination function to pass only a specific frequency band and curb components in other bands. Here, the illumination function may block unnecessary frequency components or bands containing a lot of noise in the signal and leave only frequency bands containing useful information by acting as the filter that passes only a specific frequency band of a signal in a frequency domain. This frequency band of interest may contain important information related to the position or shape of the object.

Further, the input phasor convolution module 122 may restore the signal filtered in the frequency domain back to the time domain through inverse Fourier transform (IFFT), thereby providing a more precise signal.

The time domain network module 124 may input the frequency-converted video to the time domain network implemented as a residual block for temporal information processing to generate a temporal information preserving image, and input the temporal information preserving image to the frequency domain network implemented as a convolution layer for processing frequency components of the temporal information preserving image to generate a frequency information-processed video.

More specifically, the time domain network module 124 may receive the frequency-converted video from the time domain network and convert the video into a video reflecting the temporal change of the object through temporal information processing.

The residual block is a neural network structure for solving a vanishing gradient problem that occurs when the neural network becomes deeper and preserving important features of the signal, and the residual block processes a signal in an intermediate convolution layer while transferring information input through a skip connection (residual connection) to an output as it is, and learns important temporal features so that the neural network can preserve important information on change in the signal in the time domain and process the important information.

The time domain network is a network that focuses on processing and learning temporal information of a signal, and can learn a signal changing as an object moves or time elapses, to track a dynamic object or reconstruct an image reflecting the change over time. The time domain network module 124 may generate the temporal information preserving image by the change in the signal over time being learned using the neural network through the residual block and such change being reflected in the video.

The temporal information preserving image is an image that has reflected how the object changes over time or how a signal changes over time, and can enable accurate reconstruction in a situation where the object is not static but moves or changes over time in NLOS imaging. The temporal information preserving image may visually represent not only the position of the object but also how the object moves and changes over time.

Further, the time domain network module 124 may input the temporal information preserving image to the frequency domain network implemented as a convolution layer so that frequency components are filtered and only important information remains, thereby generating the frequency information-processed video that may enable more precise object reconstruction in subsequent neural network processing.

The frequency domain network configured of a convolution layer may analyze frequency components of an input signal as frequency components instead of analyzing the frequency components of an input signal as change over time, to extract important information present in a specific frequency band or remove unnecessary noise.

The convolution layer may process the frequency components of the input signal, extract a specific pattern or emphasize information in important frequency bands, curbs noise components, and acts as a filter in the frequency domain to remove unnecessary frequency bands and leave only the frequency of interest required for object reconstruction.

Through this, the neural network processing unit 120 learns more precise information for the position and shape of the object, and can derive more accurate results in a reconstruction process.

The predicted phasor field generation module 126 may extract the frequency band of interest from the frequency information-processed video through target training to generate a predicted phasor field for predicting the hidden object.

The targeted training is a learning method based on a loss function that is used in a learning process to reduce a difference between the results predicted by the neural network and the actual results, and in this process, the predicted phasor field generation module 126 learns the important frequency components through the frequency information-processed video, and extracts the frequency band of interest to exclude unnecessary noise or frequency components and emphasize only necessary information.

The predicted phasor field generation module 126 can cause the network to be learned by measuring how much a value predicted by the network matches a position and shape of an actual object using a loss function such as an L1 loss function or a Huber loss function.

The predicted phasor field generation module 126 may accurately extract the frequency band of interest, which is a frequency range containing important information on a position and shape of the object, from the frequency information-processed video, which is a signal filtered through a convolutional layer in a previous step and in which only the important frequency components remain, using a neural network trained through target training, thereby excluding unnecessary components from the frequency band and leaving only important components to reconstruct the object more accurately.

The predicted phasor field generation module 126 may learn the frequency band of interest from the frequency information-processed video through target training to generate a predicted phasor field for predicting the position and shape of the object. The predicted phasor field is a field including information on a phase and amplitude of the wave reflected from the object, may be used to estimate an exact position and shape of the object in a subsequent step since the predicted phasor field contains important information on the position and shape of the object, and may play an important role in restoring the hidden object in high resolution.

The neural network processing unit 120 can more accurately predict the position and shape of the object by the predicted phasor field generation module 126 extracting information that more accurately reflects characteristics of the hidden object from the frequency information-processed video.

The target training module 128 may implement the target training with a loss function of controlling the outliers of the hidden object.

The outliers are values greatly deviating from other normal patterns in data, and in NLOS imaging, the outliers may be generated due to sensor noise, measurement errors, environmental factors, and the like, and since such outliers may increase errors in a prediction process of the neural network and reduce the accuracy of the reconstructed object, it is important to effectively handle the outliers.

The loss function is a function used to minimize a difference between the predicted value and the actual value during learning of the neural network, and in particular, the outlier control loss function can help learning be more stable by reducing the sensitivity of the neural network to the outliers. Commonly used outlier control loss functions include an L1 loss function and a Huber loss function. The L1 loss function is used to compute an absolute error between the predicted value and the actual value, and the network may not be greatly influenced even when there are the outliers since the L1 loss function has the characteristic of being less sensitive to the outliers. The Huber loss function is a function that is a combination of advantages of the L1 loss function and the L2 loss function, and operates like an L2 loss for a small error and like an L1 loss for a large error (outlier), thereby maintaining learning performance of the network while reducing the influence of the outliers.

$${L}_{δ} ( a ) = \{ \begin{matrix}\frac{1}{2} {a}^{2} & if \vert a \vert \leq δ \\ δ ( \vert a \vert - \frac{1}{2} δ ) & otherwise\end{matrix}$$

a denotes the difference between the predicted value and the actual value, and δ denotes the threshold.

The target training is a process of minimizing a difference between the value predicted by the network and the actual value, and it may be important to reduce unnecessary errors that may occur due to the outliers.

The outlier control loss function can prevent the network from being overly sensitive to errors due to outliers that occur during learning of the neural network, thereby increasing the stability of learning and enabling more sophisticated reconstruction.

In NLOS imaging, outliers are errors that may occur during a process of reconstructing the hidden object, and when the target training module 128 fails to process the outliers, the position or shape of the object may be incorrectly predicted.

Through the outlier control loss function, the target training module 128 can accurately reconstruct a position and shape of the hidden object by learning the important frequency components and signals while minimizing the influence of outliers.

The scene reconstruction unit 130 can determine the position and shape of the object through a Rayleigh-Sommerfeld diffraction (RSD) operation for the frequency band constituting the predicted phasor field, thereby restoring the hidden scene.

More specifically, the scene reconstruction unit 130 can reconstruct the scene to visualize the scene as a high-resolution image even in a situation where the object is not visible based on the position and shape of the object extracted through the RSD operation.

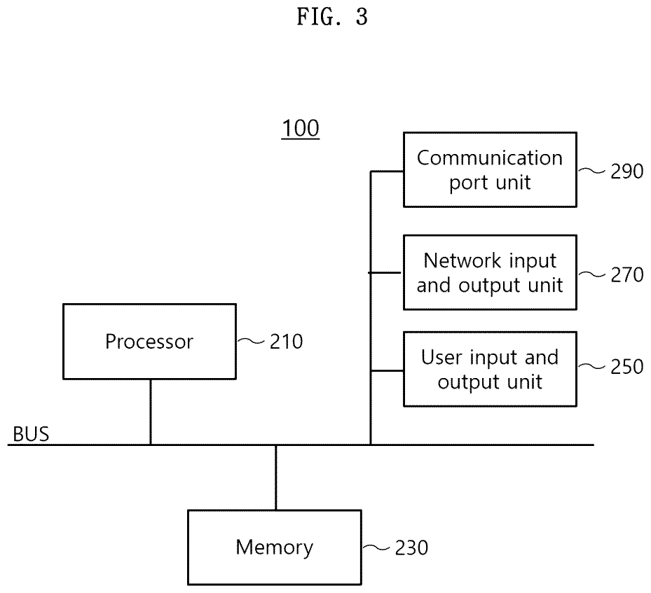

FIG. 3 is a diagram illustrating a system configuration of the artificial intelligence-based non-line-of-sight (NLOS) imaging reconstruction device of FIG. 1.

Referring to FIG. 3, the artificial intelligence-based non-line-of-sight (NLOS) imaging reconstruction device 100 may include a processor 210, a memory 230, a user input and output unit 250, a network input and output unit 270, and a communication port unit 290.

The processor 210 may receive a question including a video and text through a text-only language model and a vision-language model, generate a text response and a multimodal response to the question, manage the memory 230 that is read or written in such a process, and schedule a synchronization time between a volatile memory and a nonvolatile memory in the memory 230.

The processor 210 may control an overall operation of the multimodal language processing device based on a visual-language model 100, and may be electrically connected to the memory 230, the user input and output unit 250, the network input and output unit 270, and the communication port unit 290 to control data flows between these units. The processor 210 may be implemented as a central processing unit (CPU) or a graphics processing unit (GPU) of the multimodal language processing device based on a visual-language model 100.

The memory 230 may include an auxiliary memory device implemented as a nonvolatile memory such as a solid state disk (SSD) or a hard disk drive (HDD) and used to store all of data required for the multimodal language processing device based on a visual-language model 100, and may include a main memory device implemented as a volatile memory such as a random access memory (RAM). Further, the memory 230 may store a set of instructions that execute a role of the multimodal language processing device based on a visual-language model 100 according to the present disclosure by being executed by the electrically connected processor 210.

The user input and output unit 250 may include an environment for receiving a user input and an environment for outputting specific information to a user, and may include, for example, an input device including an adapter such as a touch pad, a touch screen, a visual keyboard, or a pointing device, and an output device including an adapter such as a monitor or a touch screen. In an embodiment, the user input and output unit 250 may correspond to a computing device connected via a remote connection, and in such a case, the multimodal language processing device based on a visual-language model 100 may function as an independent server.

The network input and output unit 270 may provide a communication environment for connection to an attack IP terminal or a test IP terminal through a network, and may include, for example, an adapter for communication such as a local area network (LAN), a metropolitan area network (MAN), a wide area network (WAN), and a value added network (VAN). Further, the network input and output unit 270 may be implemented to provide a short-distance communication function such as WiFi or Bluetooth or a wireless communication function of 4G or higher for wireless transmission of data.

The communication port unit 290 is a hardware interface for connection to external hardware, and for example, the external hardware may include a printer, a mouse, and USB hardware. The communication port unit 290 may detect a connection of specific USB hardware to perform a role of a CTI augmentation device 130.

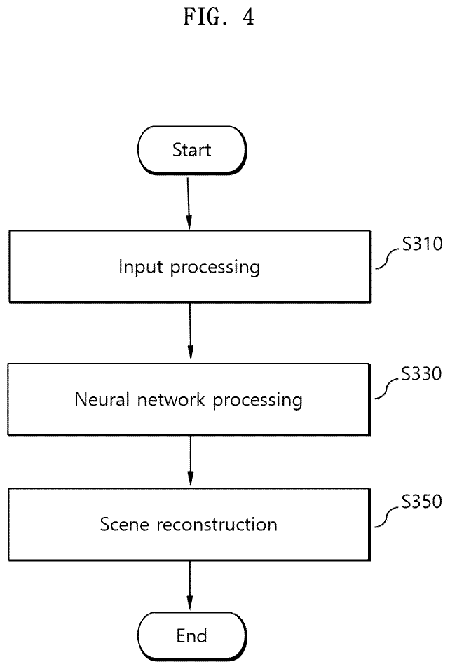

FIG. 4 is a flowchart illustrating an artificial intelligence-based non-line-of-sight (NLOS) imaging reconstruction method according to the present invention.

In FIG. 4, the artificial intelligence-based non-line-of-sight (NLOS) imaging reconstruction device 100 performs an input processing step of sampling a partial video from an original image (step S310), a neural network processing step of generating a frequency-converted video for the partial video and inputting the frequency-converted video to time and frequency domain networks to generate a predicted phasor field (step S330), and a scene reconstruction step of reconstructing a hidden scene based on the predicted phasor field (step S350).

In step S310, the input processing unit 110 may select and sample only a portion containing important information without using the entire original image.

More specifically, the input processing unit 110 may sample only an region containing the important information from the original video containing noise or unnecessary information to improve the quality of data.

In step S330, the neural network processing unit 120 may generate a frequency-converted video and input the frequency-converted video to the time and frequency domain networks, thereby generating the predicted phasor field. Through this process, the neural network processing unit 120 can accurately predict the position and shape of the object in the NLOS imaging and play an important role in restoring the hidden object.

More specifically, the neural network processing unit 120 can learn not only static characteristics of the object but also changes over time by simultaneously processing the time domain and the frequency domain, thereby deriving more precise results reflecting the movement or change of the object. The neural network processing unit 120 can greatly improve the accuracy of the object reconstruction by extracting important information from the frequency domain and removing noise components to improve the quality of a final phasor field.

In step S350, the scene reconstruction unit 130 can reconstruct the position and shape of the hidden object based on the predicted phasor field and an RSD operation result.

More specifically, the scene reconstruction unit 130 can process, in real time or near real time, a process of restoring the high-resolution image of the object and visually reconstructing what the hidden object looks like and where the hidden object is positioned, thereby contributing to accurately restoring the object in a complex environment.

### 1. Proposed Method

### 1.1. Overview of Phasor Field NLOS Imaging

The goal of non-line-of-sight (NLOS) imaging is to reconstruct the hidden scene through indirect multiple reflected light measurement, in which, when several points xₚ on a relay wall P is irradiated with a short laser pulse, light is scattered toward the hidden object, and some photons collide with an object and return to the relay wall. When several points x_c on a relay wall C are scanned, an impulse response H(xₚ→x_{c}, t) can be obtained.

In recent phasor field NLOS methods, NLOS imaging may be regarded as a diffraction wave propagation problem using a virtual camera, which can be solved by using a directly observable diffraction operator. A phasor wavefront at a virtual aperture can be computed from H(xₚ→x_{c}, t).

$$𝒫 ( {x}_{c} , t ) = {\int }_{p} \vert 𝒫 ( {x}_{p} , t ) * H ( {x}_{p} \to {x}_{c} , t ) ) {dx}_{p} , \qquad ( 1 )$$

Here, p(xₚ, t) is a wavefront of a virtual illumination source, and * is a convolution operator in time. The hidden scenes may be reconstructed by using a wave propagation operator Φ at p(xₚ, t).

$$I ( {x}_{v} ) = Φ ( 𝒫 ( {x}_{c} , t ) ) , \qquad ( 2 )$$

Here, xᵥ is a point in the imaged hidden scene. The propagation operator Φ is usually formulated by using a Rayleigh-Sommerfeld Diffraction (RSD). Diffraction-based NLOS methods have shown remarkable results, but reconstruction quality of these methods is highly dependent on the quality of measured data.

### Resolution Limit

A spatial resolution of a phasor camera is defined as follows:

$$0.61 λ L / d$$

Here, λ is a wavelength, L is an imaging distance, and d is a diameter of the virtual aperture. The minimum achievable wavelength λ is determined by a sampling distance Δp, where λ>2Δp. Therefore, when Δp is increased or d is decreased, a spatial resolution of a system is theoretically limited.

An illumination phasor field is mainly implemented as a virtual transient camera in NLOS imaging, and a short Gaussian shape flash is used. A corresponding illumination function is expressed as follows.

$$P ( xp , t ) = δ ( xp - x l s ( ei Ω Cte - t 22 σ2 )$$

Here,
δ(xp−xls) is a Dirac delta function, which represents a difference between an illumination position xls and a sampling position xp.
eiΩCt is a complex periodic function, which denotes time dependence at a specific frequency QC.
e−t22σ2 is a Gaussian function, which denotes a Gaussian-shaped pulse form for time t, and σ is a standard deviation of the Gaussian.

The Fourier transform (Fourier domain representation) of this function can be expressed as follows.

$$P \hat{} ( xp , ω ) = δ ( xp - xls ) \cdot e - σ2 ( ω - Ω C ) 2$$

This shows that the illumination function in the time domain also appears as a Gaussian shape in the frequency domain.

$$\text{?} ( {x}_{p} , Ω ) = δ ( {x}_{c} - {x}_{ls} ) ( 2 πδ ( Ω - {Ω}_{C} ) * σ \sqrt{2 π} \text{?} \qquad ( 3 )$$

$$\text{?} \text{indicates text missing or illegible when filed}$$

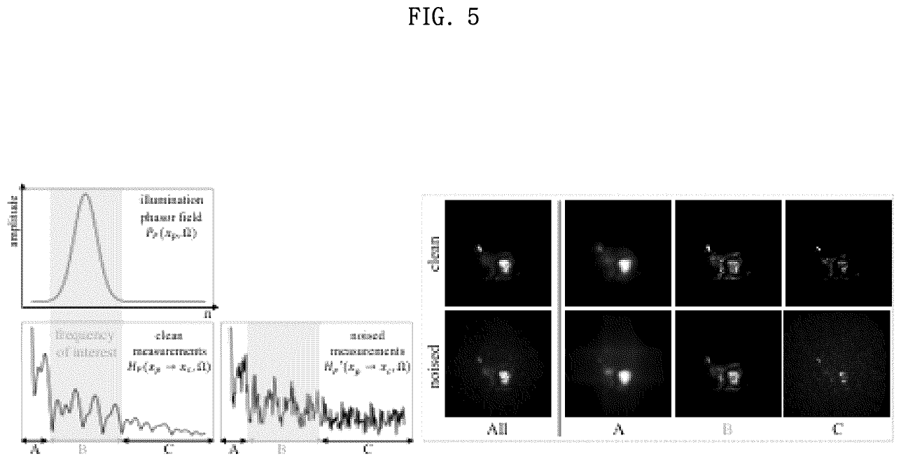

Here, xls denotes a position of a virtual light source, and ΩC is a central frequency and is determined by the wavelength λ. The illumination phasor field PF(xp,Ω) in the frequency domain is defined as a Gaussian shape (top-left in FIG. 5), which acts as a band-pass filter.

Therefore, the phasor wavefront computed at the aperture is a band-limited signal, and this means that only signals in a specific frequency range are needed to reconstruct the hidden scene. In other words, only signals in a certain frequency band are used to reconstruct the hidden scene, and unnecessary frequency components are removed.

### 1.2. Noise Removal and Frequency of Interest

In the NLOS imaging, the measurements may be degraded due to a very low signal-to-noise ratio (SNR). When the number of scan points is reduced, a total number of detected photons is decreased and an influence of noise is further amplified. Since the sensor noise is typically modeled as a Poisson distribution, a criterion for removing Poisson noise is applied to a signal recovery problem.

However, such a training scheme induces the network to recover all frequency components since the sensor noise has an influence on an entire frequency spectrum. Accordingly, in network training results, details are often lost and over-smoothed results are produced.

### Analysis of Influence of Noise on Frequency Components

To analyze an influence of the noise on the frequency components, rendered measurements of the Stanford Bunny are divided into a case with the noise and a case without the noise, and the frequency components are visualized. Further, an FK method and a band-pass filter are used to retain only components in a specific frequency range and remove other components, and then, the reconstructed scene is visualized.

### Results

As illustrated in FIG. 5, most of significant signals are observed in a central frequency range (range B). When Poisson noise is added, artifacts appear in a low frequency band, and high frequency components become difficult to distinguish from the noise. On the other hand, a signal near the central frequency still contains a clear object shape, is more robust to noise, and is easier to recover.

Such results motivate to limit a spectrum of the network and use the phasor field of the aperture as a band-limited input and output.

### 1.3. Learning to Enhance Aperture Phasor Field

Learning to enhance aperture phasor field (LEAP) that is a phasor-based neural network will be described based on the observations described above. The LEAP may predict clean and complete measurements from noisy partial observation values. An integral for the illumination function P is removed on the assumption of a single virtual illumination point xls.

### Method Overview (See FIG. 5)

First, when partial inputs are sampled from the full measurement H(xp→xc,t) and contaminated with Poisson noise, an enhancement network receives a partial input value containing such noise and predicts an optimal phasor field containing a complete scan and a clean signal at the aperture, in the frequency domain.

### Learning Process

The network is trained in a manner of minimizing a distance L1 between the phasor field predicted at the aperture and the optimal phasor field. When the training is completed, the hidden scenes are reconstructed by propagating the predicted phasor field using an RSD algorithm.

### Description of Components

### Sensor Noise Simulation

For simulation of a strong influence of the noise in the NLOS imaging, the Poisson distribution is used to model the sensor noise according to a computational model of a Single-Photon Avalanche Diode (SPAD). The sensor noise is modelled at several exposure levels in consideration of a process of calculating the number of accumulated photons.

$$X = ( η \check{H} ( {x}_{p} \to {x}_{c} ) * g ) + d , \\ {H}^{′} ( {x}_{p} \to {x}_{c} , t ) \sim Poisson ( c \cdot X ) , \qquad ( 4 )$$

Here, H′ is a noise-added measurement, and H˜ is a partially sampled measurement from an original measurement H. η is photon detection effectiveness, and g serves to model time jitter. c serves to control exposure time, and d serves to model background noise, in which ambient light and dark counts are contained. After the measurements are partially sampled and corrupted by noise, the measurements are provided as inputs to the network.

### Input Phasor Field Convolution

The partial input to which the noise has been added is then convolved with several illumination functions. A set of illumination wavefronts with several wavelengths are used, and such a frequency range is selected as a frequency close to a target frequency range.

A convolution output F={f1, f2, . . . , fi} for several wavelengths {λ1, λ2, . . . , Δi} is computed by using a convolution theorem in the frequency domain. This can be described as follows:

$$F i = F ( {H}^{′} ) * F ( P λ i )$$

Here, F denotes the Fourier transform, H′ is a partial measurement containing noise, and Pλi is an illumination function for a specific wavelength λi. According to a convolution theorem in the frequency domain, a convolution between an input signal and an illumination function for several wavelengths can be processed efficiently.

$${f}_{i} ( {x}_{c} , t ) = {ℱ}^{- 1} ( ℱ ( {H}^{′} ( {x}_{p} \to {x}_{c} ) , t ) \cdot {𝒫}_{ℱ}^{i} ( {x}_{p} , Ω ) ) , \qquad ( 5 )$$

Here, PFi(xp,Ω) is an illumination phasor field corresponding to a wavelength λi in the frequency domain. Both real and imaginary components are concatenated into F and passed to the enhancement network for feature extraction.

### Enhancement Network

A 3D residual convolutional neural network (CNN) is used as the enhancement network. This network extracts feature volumes from F through several 3D residual blocks and transforms the feature volumes into a frequency domain. Then, three convolutional layers extract additional features from these frequency volumes to predict residuals. The residuals contain both a real part and an imaginary part in the frequency domain.

These residuals are added to an upsampled (and zero-padded in the case of a small aperture) input value to predict a clean and complete measurement H\hat{ }(xp→xc,Ω). The model ultimately computes the aperture phasor field

$$P \hat{} F ( xp \to xc , Ω )$$

This network receives partial input values containing noise, and extracts features in the frequency domain to predict a complete signal with the noise removed.

$${\hat{𝒫}}_{ℱ} ( {x}_{c} , Ω ) = \hat{H} ( {x}_{p} \to {x}_{c} , Ω ) \cdot {𝒫}_{ℱ} ( {x}_{p} , Ω ) . \qquad ( 6 )$$

Here, PF(xp,Ω) denotes a target illumination phasor wavefront, and has a wavelength λT. This is also used to compute a ground truth phasor field.

Since the network is configured of only 3D convolution blocks compared to spatially shifted networks (SSNs) and does not include computationally expensive attention branches, the effectiveness of the model is improved.

### Training Objective and Reconstruction

To cause the network to be learned, an L1 distance between a predicted phasor field P\hat{ }F(xc,Ω) and a target phasor field PF(xc,Ω) is minimized. A target aperture wavefront is computed by performing convolution of optimal measurements with a target illumination function PF(xp,t).

Since significant frequency components required to reconstruct the hidden scene are determined by the wavelength λT, a loss is minimized only for such components. The learning objective of this method can be described as follows:

$$L = \sum Ω \vert P \hat{} F ( xc , Ω ) - P F ( x c , Ω )$$

This loss function computes a difference between the predicted phasor field and the target phasor field, and the network is trained to predict a more accurate phasor field.

$$ℒ = {\sum }_{{Ω}^{′} ∈ S} {‖ {\hat{𝒫}}_{ℱ} ( {x}_{c} , {Ω}^{′} ) - {𝒫}_{ℱ} ( {x}_{c} , {Ω}^{′} ) ‖}_{1} . \qquad ( 7 )$$

Here, S denotes a frequency range, which is defined as follows:

$$S = [ Ω C - Δ Ω , Ω C + Δ Ω ]$$

This range is a frequency range where a coefficient of an input wavefront is greater than a maximum ratio γ. The central frequency ΩC is determined by a target wavelength λT. When the network is trained based on an aperture wavefront, a training objective of the network is limited to a frequency range of interest.

After the network predicts the enhanced phasor field from the aperture, the hidden scenes can be reconstructed by using existing wave propagation operators. A reconstruction task is performed by using the RSD algorithm based on a 2D fast Fourier transform (FFT).

This process estimates a position and shape of the hidden object through the significant signals in the frequency range, and enables accurate reconstruction in an NLOS environment.

### 2. Experiment

To demonstrate the effectiveness of the proposed method, experiments are performed under two practical acquisition scenarios: (1) sparse sampling and (2) small aperture scanning.

### Evaluation Scenarios

The acquisition scenarios are divided into a total of four settings.
Conf-16: confocal sparse scanning with 16×16 sampling.
Conf-8: confocal sparse scanning with 8×8 sampling.
Conf-small: confocal scanning with 16×16 sampling in a small region with a size of 1 m×1 m.
Non-16: Non-confocal sparse scanning at 16×16 points.

According to previous studies, the performance is evaluated in a partial sampling scenario, and sampling points are uniformly sampled while maintaining an appropriate spatial spacing in all the measurements (a center-crop scheme is used in the case of a small aperture). The goal is to recover the measurements with a 2 m×2 m aperture, a temporal resolution of 32 ps, and 64×64 sampling. Accordingly, hidden volumes having a size of 64×64×64 are reconstructed.

### Baselines

The proposed method was compared with the following representative baselines:
FK, LCT, RSD: a nearest interpolation method and a trilinear interpolation method were used.
SSCR: Optimization-based few-shot NLOS method.
LFE, USM, SSN: Learning-based methods. SSN is a scheme for recovering missing signals from partial measurements, and the USM is configured of a signal recovery network, a feature propagator, and a volume refinement module by extending an LFE architecture.

Since a code of the SSN is not disclosed, SSN is reproduced based on an original paper. Results of the learning-based method are reproduced using synthetic data. For a fair comparison, the LFE and the USM are modified to use RSD as a propagation operator, trained with noise augmentation, and supervised by a 2D label generated by projecting an RSD output using the optimal measurements.

### Implementation Details

The model was implemented in PyTorch and was trained during 160 epochs on an RTX A5000 GPU. A training process was completed within a day in an environment.
Seven wavelengths were used for input phasor field convolution.
γ=0.1 and the target wavelength λT=9.375 cm.
2D projection results of all methods (models and baselines) are obtained by using a maximum intensity projection.

### 2.1 Synthetic Dataset Evaluation

To train and validate the model, a synthetic NLOS dataset was generated by using data provided by ShapeNet. The data was generated by using an NLOS renderer, and a total of 15,000 objects were used. Among the objects, 11,000 objects were used for training and 4,000 objects were used for validation.

The generated synthetic dataset has the following characteristics:
Scan region: 2 m×2 m
Sampling points: 64×64
Temporal resolution: 32 ps (including temporal jitter)

### Quantitative Comparison

A peak signal-to-noise ratio (PSNR) and a structural similarity index (SSIM) were measured to evaluate the visual quality of the model, and root mean square error (RMSE) was used to evaluate a reconstructed geometric accuracy. The 2D projection results using the optimal measurement of the RSD were used as ground truth intensity images.

A comparison with methods based on RSD was performed due to a difference in albedo reconstruction values. A comparison with nearest interpolation (RSDNearest), trilinear interpolation (RSDLinear), and learning-based methods was performed, and evaluation was performed by using a sensor noise model.

### Results

Table 1 shows quantitative results for four evaluation scenarios on the synthetic dataset. The proposed model outperforms all other methods in terms of visual quality and geometric accuracy. The RSD shows the worst performance in both the interpolation methods.
The SSN fails to learn robust representations from noisy measurements, resulting in inaccurate results.
The LFE fails to derive meaningful results, which shows that it was difficult to use incorrectly propagated feature volumes.
The USM adds a signal recovery network to LFE to improve the performance, and provides second best results.

Nevertheless, a performance gap between the USM and the proposed model shows that a phasor-based scheme better induces the model to effectively extract significant signals from a noisy partial input.

TABLE 1
Quantitative results on the synthetic dataset. RMSE values of USM [symbol] are
omitted as its original version does not include depth map reconstruction.

| | Conf-16 | | | Conf-8 | | | Conf-small | | | Non-16 | | |
|---|---|---|---|---|---|---|---|---|---|---|---|---|
| Method | PSNR↑ | SSIM↑ | RMSE↓ | PSNR↑ | SSIM↑ | RMSE↓ | PSNR↑ | SSIM↑ | RMSE↓ | PSNR↑ | SSIM↑ | RMSE↓ |
| RSD_{Nearest} | 14.85 | 0.1515 | 0.8232 | 12.65 | 0.0855 | 0.8919 | 19.73 | 0.3743 | 0.3073 | 19.67 | 0.3218 | 0.5020 |
| RSD_{Linear} | 14.62 | 0.1631 | 0.7536 | 11.28 | 0.0760 | 0.8884 | 19.90 | 0.4664 | 0.2046 | 19.29 | 0.3224 | 0.4856 |
| LFE [symbol] | 23.05 | 0.6729 | 0.2247 | 17.45 | 0.4098 | 0.3282 | 22.92 | 0.6826 | 0.2852 | 29.47 | 0.8077 | 0.2898 |
| USM [symbol] | 29.99 | 0.8994 | — | 25.75 | 0.8235 | — | 26.94 | 0.8519 | — | 35.14 | 0.9313 | — |
| SSN [symbol] | 23.27 | 0.4506 | 0.2699 | 21.49 | 0.4426 | 0.2259 | 21.98 | 0.4629 | 0.2036 | 29.45 | 0.6367 | 0.1798 |
| Ours | 32.02 | 0.8949 | 0.0892 | 28.07 | 0.8472 | 0.0962 | 28.31 | 0.8556 | 0.0969 | 37.45 | 0.9625 | 0.1414 |

### 2.2 Confocal Real-World Evaluation

To evaluate an ability of the proposed model to generalize real-world measurements, results were compared on a Stanford confocal real-world dataset. Bike and dragon instances were selected as evaluation targets, and were more difficult to reconstruct than other instances due to a small number of photons and a low signal-to-noise ratio (SNR).

Original measurements of a Stanford dataset were captured with 512×512 sampling, 2 m×2 m aperture, and 32 ps temporal resolution. The measurements were first downsampled two times to slightly increase an exposure time per pixel, and then the partial measurements were sampled using spatial intervals and center crops. Measurements with an exposure time of about 55 ms were used, which corresponds to a 60-minute exposure time of the original measurements.

The trilinear interpolation and LFE results were omitted due to space constraints.

### Sparse Sampling Results

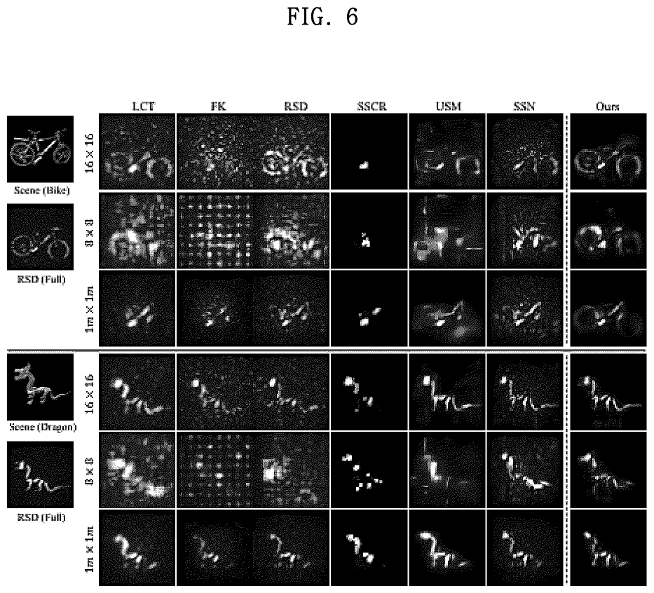

Results for a 16×16 sparse sampling scenario are illustrated in FIG. 6 (first and fourth rows). The proposed model outperformed other baselines and produced clean results with details. Inverse NLOS methods using a nearest interpolation method reconstruct only coarse shapes, and are difficult to identify objects due to artifacts in most cases. SSCR reconstructed only a part of the object, and SSN derived results containing serious artifacts due to lack of a denoising function. USM produced overall plausible results, but some artifacts were observed.

On the other hand, the proposed model successfully reconstructed a clean shape including details such as a rear wheel of a bike and a head of a dragon.

In an 8×8 sparse sampling scenario (4 times shorter scan time than 16×16), other baselines failed to produce plausible results (see second and fifth rows in FIG. 6). On the other hand, the proposed method provided results where several object parts such as the wheel of the bike and the legs of the dragon are clearly visible. In the sparse sampling scenario, the results of the proposed model showed the effectiveness of a phasor-based network in a real-world noisy environment, and the model led to significant improvements over other baselines.

### Smaller Aperture Results

The proposed model achieved high-quality results even in a small aperture scenario (see third and sixth rows in FIG. 6). The nearest interpolation method includes only a coarse shape of the object near the aperture and serious artifacts, SSCR misses many parts of the object, USM produces a distorted shape of the object, and SSN is influenced by noise.

On the other hand, the proposed method shows that the proposed model can be applied even under limited aperture conditions by reconstructing many parts of the object, such as a bike wheel, which is disposed outside the aperture.

### 2.3 Non-Confocal Real-World Evaluation

Finally, the proposed method is evaluated in a non-confocal 16×16 sparse sampling scenario. The results were compared by using measurements provided in Resolution. The measurements were captured with a 1.8 m×1.3 m aperture, a sampling interval of 1 cm, a temporal resolution of 4 ps, and exposure time of 1 second. First, spatial zero-pad and temporal averaging were applied to fit the measurements to a 2 m×2 m aperture and the temporal resolution of 32 ps, and then partial inputs were sampled using spatial intervals.

### Results

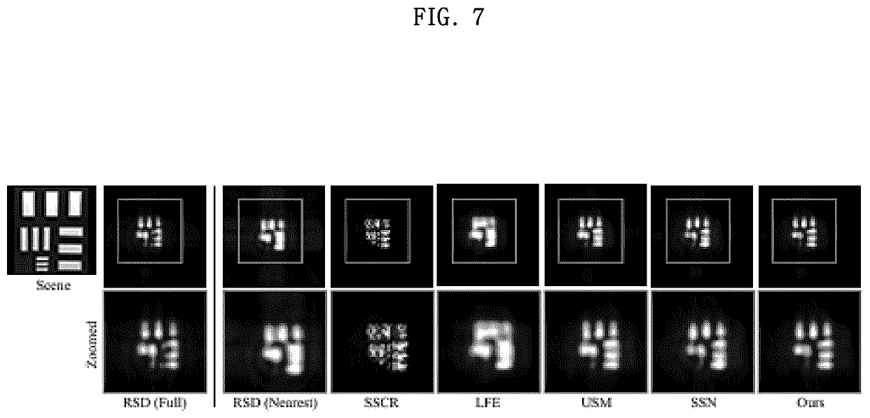

As illustrated in FIG. 7, the proposed model shows results close to all the measurements of RSD and has greatly improved performance, whereas the RSD results using an interpolation method are blurry and contain artifacts. LFE reconstructed only a coarse shape of the object. Interestingly, all learning-based methods (the USM, the SSN, and the proposed method) using a signal recovery network seem to produce convincing results under a low-noise condition. This condition corresponds to a case where the exposure time per pixel is sufficient (about 20 times longer than the Stanford dataset) and a target object having high reflectivity is included.

### 2.4 Ablation Study

To confirm effects of a proposed concept, ablation experiments were performed on confocal and non-confocal 16×16 sparse sampling scenario.

### Denoising and Phasor-Based Network

First, an ablation experiment was performed on the denoising criterion for the signal recovery problem to compare the proposed model with several signal recovery network variants.
SSN.
SSN learned with the addition of the denoising criterion (SSN+)
Enhancement network in the time domain (excluding the phasor-based scheme, Ourstime)—two versions with and without the denoising criterion

Results for bike and resolution instances in the real-world evaluation were reported.

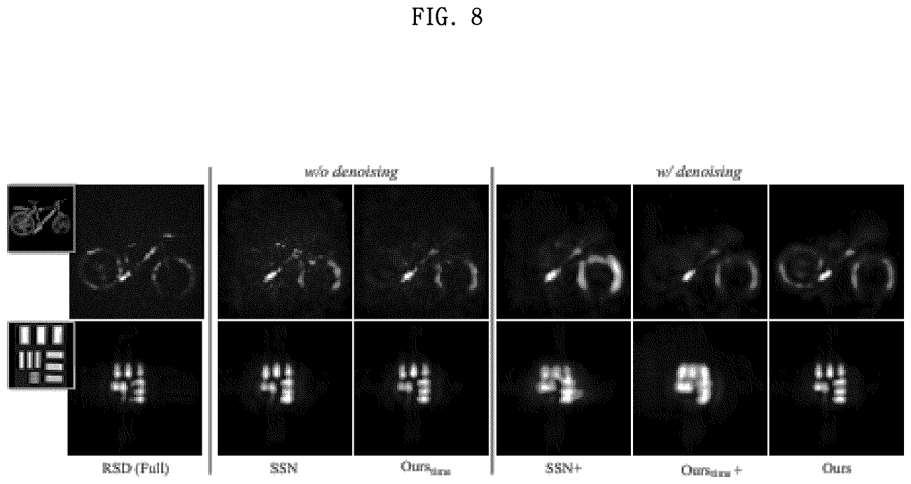

Ablation results for the synthetic dataset and real-world measurements may be confirmed from Table 2 and FIG. 8. Adding a denoising criterion greatly helps the network remove background noise and learn a more robust representation. However, as illustrated in FIG. 8, applying the denoising criterion often results in excessive smoothing resolution and loss of details (for example, a rear wheel of the bike) of the object.

When the phasor-based scheme is applied, the proposed model achieves both quantitative improvement and qualitative improvement, and produces clean results with details. In particular, the attention branches used in SSN do not provide meaningful improvements compared to the proposed model, but rather degrade the output and incur high computational costs. Based on such results, simple application of denoising may often lead to unwanted results, and emphasizes the effectiveness of the phasor-based network.

TABLE 2
Ablation results on the denoising criterion. ‘+’ indicates that the models
(SSN+, Oursₜᵢₘₑ+) are trained with the denoising criterion.

| | |
|---|---|
| Conf-16 | Non-16 |

| Method | PSNR↑ | RMSE↓ | PSNR↑ | RMSE↓ |
|---|---|---|---|---|
| SSN [symbol] | 23.27 | 0.2699 | 29.45 | 0.1798 |
| Oursₜᵢₘₑ | 23.85 | 0.2352 | 29.89 | 0.1736 |
| SSN+ | 29.55 | 0.0949 | 33.47 | 0.1435 |
| Oursₜᵢₘₑ+ | 30.69 | 0.0924 | 36.36 | 0 1423 |
| Ours | 32.02 | 0.0892 | 37.45 | 0.1414 |

### Frequency Filtering

Next, effects of frequency filtering were explored by modifying the target illumination function through a comparison with two illumination functions.
A low-pass filter that passes all frequencies less than the central frequency ΩC\Omega_CΩC.
A high-pass filter that passes all frequencies higher than the central frequency ΩC\Omega_CΩC.

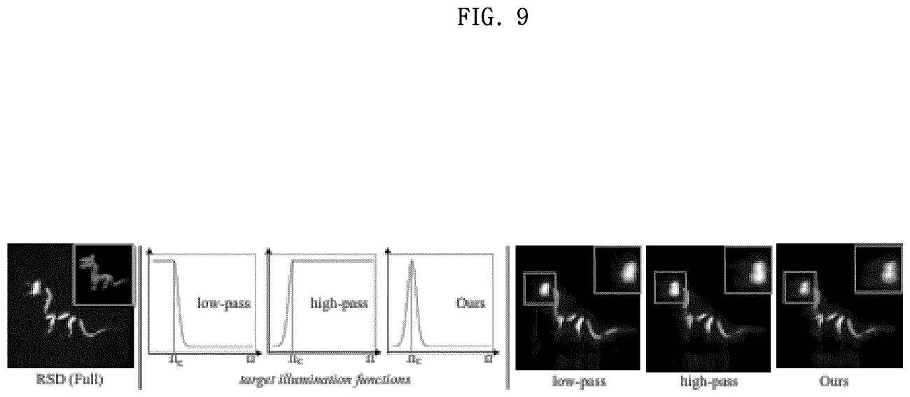

A form of each illumination function is illustrated in FIG. 9, and a frequency range thereof is closely related to FIG. 5. These models use additional wavelengths in the input phasor field convolution to sufficiently handle the target frequency range.

As reported in Table 3 and FIG. 9, low-pass and high-pass models show poor performance compared to the proposed model. Interestingly, the low-pass model shows worse results than the high-pass model, and fails to reconstruct details of the object from real-world data (for example, a head of a dragon). This is consistent with a spectral bias of the neural network with respect to low-frequency signals found in the previous studies.

Such results prove that supervising the network using phasor wavefronts as band-limited signals helps the neural network effectively avoid the spectral bias.

TABLE 3
Ablation results on the phasor-based frequency filtering. The “low-
pass” model passes frequencies lower than the central frequency Ω_{C},
and the “high-pass” model passes frequencies higher than Ω_{C}.

| | |
|---|---|
| Conf-16 | Non-16 |

| Method | PSNR↑ | RMSE↓ | PSNR↑ | RMSE↓ |
|---|---|---|---|---|
| low-pass | 31.23 | 0.0903 | 36.72 | 0.1420 |
| high-pass | 31.54 | 0.0909 | 37.09 | 0.1422 |
| Ours | 32.02 | 0.0892 | 37.45 | 0.1414 |

A learning-based method called LEAP can improve the partial measurement containing noise and enable a Non-Line-of-Sight (NLOS) video with fewer samples and smaller apertures. An enhancement network using a phased-based scheme has proved effects by showing results of high accuracy while being robust to noise in various scanning scenarios. This method may be an effective solution for solving excessive scanning procedures in an NLOS video.

Although the preferred embodiments of the present invention have been described above, it will be understood by those skilled in the art that the present invention can be variously modified and changed without departing from the scope and spirit of the present invention described in the claims below.

### [National Research and Development Project Supporting the Present Invention]

Project Serial No: 2710006677
Project No RS-2020-II201361
Name of department: Ministry of Science and ICT
Task management (professional) institution name: Institute of Information and Communications Technology Planning and Evaluation
Research Project Name: Nurturing ICT and Broadcasting Innovation Talents (R&D)
Research Task Name: Artificial Intelligence Graduate School Support Project (Yonsei University)
Name of task performing organization: University Industry Foundation, Yonsei University
Research Period: 2024.01.01˜2024.12.31
Project Serial No: 1711193622 Project No RS-2021-II212068
Name of department: Ministry of Science and ICT
Task management (professional) institution name: Institute of Information and Communications Technology Planning and Evaluation (National Research Foundation of Korea)
Research Project Name: Information and Communication/Broadcasting Research and Development Project
Research Task Name: [Hosted by Korea University] Artificial Intelligence Innovation Hub Research and Development
Name of task performing organization: University Industry Foundation, Yonsei University
Research Period: 2024.01.01˜2024.12.31

### DETAILED DESCRIPTION OF MAIN ELEMENTS

100: Artificial intelligence-based non-line-of-sight (nlos) imaging reconstruction
110: Input processing unit
120: Neural network processing unit
130: Scene reconstruction unit
122: Input phasor convolution module
124: Time domain network module
126: Predicted phasor field generation module
128: Target training module

What is claimed is:

1. An artificial intelligence-based non-line-of-sight (NLOS) imaging reconstruction device, comprising:
an input processing unit configured to sample a partial video from an original image;
a neural network processing unit configured to generate a frequency-converted video for the partial video and input the frequency-converted video to time and frequency domain networks to generate a predicted phasor field; and
a scene reconstruction unit configured to reconstruct a hidden scene based on the predicted phasor field.

2. The artificial intelligence-based non-line-of-sight (NLOS) imaging reconstruction device of claim 1, wherein the input processing unit performs denoising through sensor noise simulation on the partial video to generate a denoised partial video.

3. The artificial intelligence-based non-line-of-sight (NLOS) imaging reconstruction device of claim 1, wherein
the neural network processing unit performs an input phasor convolution for generating the frequency-converted video by performing FFT transform, application of an illumination function, and IFFT transform on the partial video, and
the illumination function extracts a frequency band of interest by passing a specific frequency band in a frequency band of the partial video.

4. The artificial intelligence-based non-line-of-sight (NLOS) imaging reconstruction device of claim 3, wherein the neural network processing unit inputs the frequency-converted video to the time domain network implemented as a residual block for temporal information processing, to generate a temporal information preserving image.

5. The artificial intelligence-based non-line-of-sight (NLOS) imaging reconstruction device of claim 4, wherein the neural network processing unit inputs the temporal information preserving image to the frequency domain network implemented as a convolutional layer for processing frequency components of the temporal information preserving image, to generate a frequency information-processed video.

6. The artificial intelligence-based non-line-of-sight (NLOS) imaging reconstruction device of claim 5, wherein the neural network processing unit extracts a frequency band of interest from the frequency information-processed video through target training, to generate the predicted phasor field for predicting the hidden object.

7. The artificial intelligence-based non-line-of-sight (NLOS) imaging reconstruction device of claim 6, wherein the neural network processing unit implements the target training using a loss function for controlling outliers of the hidden object.

8. The artificial intelligence-based non-line-of-sight (NLOS) imaging reconstruction device of claim 1, wherein the scene reconstruction unit determines a position and shape of the object through a Rayleigh-Sommerfeld diffraction (RSD) operation for the frequency band constituting the predicted phasor field, to restore the hidden scene.

9. An artificial intelligence-based non-line-of-sight (NLOS) imaging reconstruction method performed in an artificial intelligence-based non-line-of-sight (NLOS) imaging reconstruction device, the artificial intelligence-based non-line-of-sight (NLOS) imaging reconstruction method comprising:
an input processing step of sampling a partial video from an original image;
a neural network processing step of generating a frequency-converted video for the partial video and inputting the frequency-converted video to time and frequency domain networks to generate a predicted phasor field; and
a scene reconstruction step of reconstructing a hidden scene based on the predicted phasor field.
